(19) United States
(12) Patent Application Publication
(10) Pub. No.: US 2025/0389821 A1
(43) Pub. Date: Dec. 25, 2025

(54) Coherent Lidar Receiver for High-Energy Lasers

(71) Applicant: UNITED STATES OF AMERICA AS REPRESENTED BY THE ADMINISTRATOR OF NASA, WASHINGTON, DC (US)

(72) Inventors: Adam A. MEDINA, Williamsburg, VA (US); Grady J. KOCH, Huntsville, AL (US)

(21) Appl. No.: 18/753,027

(22) Filed: Jun. 25, 2024

(51) Int. Cl. G01S 7/486; G01S 7/481; G01S 7/484; G01S 17/95

(52) U.S. Cl. CPC G01S 7/486; G01S 7/484; G01S 7/4814; G01S 7/4816; G01S 17/95

(57) ABSTRACT

A lidar receiver for use with a fiber laser transmitter that generates a high pulse-energy output beam and a pulsed local oscillator laser beam. The lidar receiver includes an atmospheric backscatter routing assembly having a thin-film beam splitter to reflect atmospheric backscatter while allowing the high pulse-energy output beam to pass through the beam splitter. The beam splitter has a dielectric coating to minimize absorption. The backscatter routing assembly includes a first optical assembly having a half-wave plate and dielectric laser mirrors to direct atmospheric backscatter reflected by the beam splitter to the half-wave plate. The dielectric laser mirrors are configured to minimize absorption. The backscatter routing assembly includes a second optical assembly having a mode-matching optical assembly and output optical fiber. The mode-matching optical assembly couples the atmospheric backscatter emitted by the half-wave plate to the output optical fiber. The output optical fiber is coupled to a detector.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Light Detection and Ranging (LiDAR) is a remote sensing technology that uses light pulses or continuous light waves to measure ranges or distances of an object. A LiDAR system may include a telescope, one or more lenses, or one or more mirrors configured to expand focus or collimate the output light pulses or the reflected or scattered light to a desired beam diameter. In Doppler LiDAR systems, the reflected or scattered light is shifted in frequency and then analyzed to determine line-of-sight velocity of the target. LiDAR has application in various fields including, but not limited to, meteorology, bathymetry, archeology, space, aerospace, aviation, military operations and law enforcement. For example, LiDAR may be used to obtain information about atmospheric aerosols, clouds, precipitation, gas concentration, and hard target distance and velocity. LiDAR is also used in obtaining wind data at various altitudes. Wind data, such as wind vector measurements, has many uses in meteorology, atmospheric science, wind energy and aviation safety. There are many benefits to improved wind data collection methods and technology including, but not limited to, transformational improvements in the accuracy of weather forecasts, tracking of greenhouse gasses and pollution, fire mitigation, weather-based loss mitigation, and the understanding of the effects of atmospheric and atmosphere-ocean processes as they relate to global climate change investigations. However, prior art LiDAR systems are limited in performance in the maximum distance at which measurements may be obtained. For example, a typical, prior art Doppler LiDAR can make measurements only to a few kilometers when there is an ideal high-aerosol loading of the atmospheric boundary layer. Yet, many wind measurement applications require measurements to be made at distances greater than a few kilometers and, possibly, within conditions of low-aerosol content as found in the free troposphere. One prior art solution to this problem of obtaining wind measurements at greater distances in low-aerosol conditions is the use of a laser transmitter having an output pulse-energy that is greater than the output pulse- energy currently used in commercial wind lidars, which is typically less than 1.0 millijoules (mJ). For example, recently developed laser transmitters are capable of pulse-energy significantly greater than 1.0 mJ. However, conventional fiber-based receiver designs cannot handle the high pulse-energy produced by these recently developed laser transmitters. Specifically, the conventional approach of using directly fiber-coupled components in a lidar receiver does not work as the laser pulse-energy approaches 1 mJ because the high laser pulse-energy in the confined cross-section of the fiber laser may burn the fiber’s surfaces and the glass of the fiber core. When such burning occurs, the laser beam is greatly attenuated, the phase front is degraded, and the lidar system is rendered useless. One solution to solve this problem entailed the use of larger area fibers for the distribution of the energy load. However, the larger area fibers inadvertently create multi-mode operation, thereby degrading the phase front required for coherent detection.

### BRIEF SUMMARY OF THE INVENTION

One embodiment is directed to a lidar receiver for use with a fiber laser transmitter configured to generate a high pulse-energy output beam having a first linear polarization and a first frequency and a pulsed local oscillator laser beam having a second frequency offset from the first frequency. The lidar receiver comprises a backscatter routing assembly having a quarter-wave plate configured to receive atmospheric backscatter having a circular polarization and convert the circular polarization to a second linear polarization, a beam splitter configured to reflect the atmospheric backscatter having the second linear polarization while allowing the high pulse-energy output beam having the first linear polarization to pass through the beam splitter, and a first optical assembly having a half-wave plate and a pair of dielectric laser mirrors to direct atmospheric backscatter reflected by the beam splitter to the half-wave plate. The half-wave plate is configured to optimize the second linear polarization of the atmospheric backscatter. The backscatter routing assembly further comprises a second optical assembly having an output optical fiber and a mode-matching optical assembly for coupling the atmospheric backscatter emitted by the half-wave plate to the output optical fiber. The lidar receiver further comprises a detector having a fiber optic coupler coupled to the output optical fiber and the pulsed local oscillator laser beam and configured to provide at least one output signal that comprises a portion of the atmospheric backscatter and a portion of the pulsed local oscillator laser beam. The detector includes a photodetection circuit for converting the at least one output signal into an electrical signal usable for signal processing. In one embodiment, the detector is configured as a dual-balanced detector. In another embodiment, the detector is configured as a single-ended detector.

Another embodiment is directed to a lidar receiver for use with a fiber laser transmitter that generates a high pulse-energy output beam having a first linear polarization and a first frequency and a pulsed local oscillator laser beam having a second frequency offset from the first frequency. The lidar receiver comprises a backscatter routing assembly comprising a quarter-wave plate configured to receive atmospheric backscatter having a circular polarization and convert the circular polarization to a second linear polarization, a thin-film beam splitter configured to reflect the atmospheric backscatter having the second linear polarization while allowing the high pulse-energy output beam having the first linear polarization to pass through the beam splitter. The thin-film beam splitter is configured with a dielectric coating to minimize absorption. The backscatter routing assembly further comprises a first optical assembly comprising a half-wave plate and a pair of dielectric laser mirrors to direct the atmospheric backscatter reflected by the beam splitter to the half-wave plate. The half-wave plate is configured to optimize the second linear polarization of the atmospheric backscatter. The backscatter routing assembly further comprises a second optical assembly comprising an output optical fiber and a mode-matching optical assembly for coupling the atmospheric backscatter emitted by the half-wave plate to the output optical fiber. The lidar receiver further comprises a detector comprising a fiber optic coupler coupled to the output optical fiber and the pulsed local oscillator laser beam and configured to provide a pair of output signals. Each output signal comprises about 50% of the atmospheric backscatter and about 50% of the pulsed local oscillator laser beam. The detector further comprises a dual-balanced photodetection circuit configured for receiving the light from the pair of output signals and in response, generating an electrical signal usable for signal processing.

Yet another embodiment is directed to a lidar system comprising a fiber laser transmitter configured to generate a high pulse-energy output beam having a first linear polarization and a first frequency and a pulsed local oscillator laser beam having a second frequency offset from the first frequency. The lidar system further comprises a first optical assembly comprising a first half-wave plate and a first pair of dielectric laser mirrors to direct the high pulse-energy output beam to the first half-wave plate. The first half-wave plate is configured to rotate the polarization of the high pulse-energy output beam. The lidar system further comprises a beam splitter configured to allow the high pulse-energy output beam emitted by the first half-wave plate to pass through the beam splitter while simultaneously reflecting atmospheric backscatter having a second linear polarization. The lidar system further comprises a quarter-wave plate configured to convert the first linear polarization of the high pulse-energy output beam emitted by the beam splitter to a first circular polarization. The lidar system further includes a beam expander configured to emit the high pulse-energy output beam having the first circular polarization into the atmosphere toward a target of interest and collect atmospheric backscatter having a second circular polarization that is opposite the first circular polarization. The quarter-wave plate is further configured to convert the second circular polarization of the atmospheric backscatter to the second linear polarization. The beam splitter reflects the atmospheric backscatter having the second linear polarization. The lidar system further comprises a second optical assembly comprising a second half-wave plate and a second pair of dielectric laser mirrors to direct the atmospheric backscatter reflected by the beam splitter to the second half-wave plate. The second half-wave plate is configured to optimize the second linear polarization of the atmospheric backscatter. The lidar system further comprises a third optical assembly comprising an output optical fiber and a mode-matching optical assembly configured to couple the atmospheric backscatter emitted by the second half-wave plate to the output optical fiber. The lidar system further includes a detector comprising a fiber optic coupler that is coupled to the output optical fiber and the pulsed local oscillator laser beam and configured to provide at least one output signal that comprises a portion of the atmospheric backscatter and a portion of the pulsed local oscillator laser beam. The detector further comprises a photodetection circuit for converting the at least one output signal into an electrical signal usable for signal processing.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a schematic block diagram illustrating a coherent Doppler lidar system in accordance with an embodiment of the present invention; and

FIG. 2 is a schematic block diagram of a single-ended detector that may be used in place of a dual-balanced detector shown in FIG. 1.

### DETAILED DESCRIPTION OF THE INVENTION

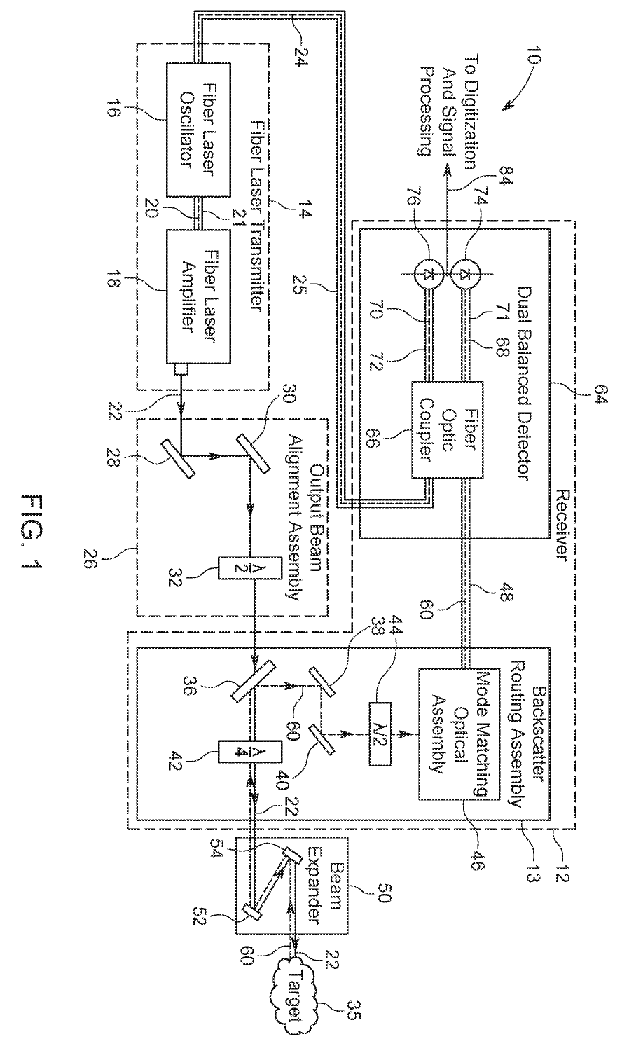

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the terms “comprise”, “comprises”, “comprising”, “include”, “includes”, “including”, “has”, “having” or any other variation thereof, are intended to cover a non-exclusive inclusion. For example, an apparatus, system, process, method or article that comprises a list of elements is not necessarily limited to only those elements, but may include other elements not expressly listed or inherent to such apparatus, system, process, method or article.

Approximating language, as used herein throughout the specification and claims, may be applied to modify any quantitative representation that could permissibly vary without resulting in a change in the basic function to which it is related. Accordingly, a value modified by a term such as “about” or “approximately” is not limited to the precise value specified.

FIG. 1 shows a coherent Doppler lidar system 10 in accordance with an exemplary embodiment of the present approach. Lidar system 10 comprises lidar receiver 12 and fiber laser transmitter 14. Lidar receiver 12 comprises backscatter routing assembly 13 and dual-balanced detector 64 which are described in detail in the ensuing description. Fiber laser transmitter 14 is a pulsed laser system that produces a high pulse-energy laser beam that exceeds 1.0 millijoule (mJ). Fiber laser transmitter 14 comprises fiber laser oscillator 16 and fiber laser amplifier 18. Fiber laser oscillator 16 is configured to generate a spectrally pure pulsed laser beam 20 that is provided to fiber laser amplifier 18 via optical fiber 21. Fiber laser amplifier 18 amplifies pulsed laser beam 20 so as to output a high pulse-energy laser beam, referred to herein as “output beam 22”. Output beam 22 has a linear polarization, referred to herein as the “first linear polarization”. Output beam 22 has a frequency F_{OB} and a relatively high laser pulse-energy that exceeds 1.0 mJ. Fiber laser oscillator 16 is configured to split off a pulsed local oscillator laser beam 24 from pulsed laser beam 20. Pulsed local oscillator laser beam 24 is optically coupled into optical fiber 25. As shown in FIG. 1, optical fiber 25 is optically coupled to dual-balanced detector 64. Pulsed local oscillator laser beam 24 has a frequency F_{LO} that is offset from the frequency F_{OB} such that subtracting frequency F_{LO} from frequency F_{OB} (or subtracting frequency F_{OB} from frequency F_{LO}) yields a difference frequency, or what is known as an intermediate frequency F_{IF}. Fiber laser oscillator 16 is configured so that intermediate frequency F_{IF} remains constant even if the frequencies F_{LO} and F_{OB} increase or decrease. Thus, the difference in frequencies F_{LO} and F_{OB} will always remain the same. In an exemplary embodiment, the intermediate frequency F_{IF} is 100 MHz. It has been found that an intermediate frequency F_{IF} of 100 MHz provides several advantages and benefits. First, such an intermediate frequency F_{IF} improves discernment of positive and negative Doppler shifts in atmospheric backscatter 60. Secondly, lidar system operation is significantly improved when used in a fast-moving aircraft which inherently produces a large frequency offset. Thirdly, an intermediate frequency F_{IF} of 100 MHz allows for a wider selection of electro-optics modulators that may be used in fiber laser transmitter 14. However, it is to be understood that other intermediate frequencies F_{IF} may be used as well. For instance, in another exemplary embodiment, F_{IF} may be 160 MHz. Pulsed local oscillator laser beam 24 and the intermediate frequency F_{IF} are further discussed in the ensuing description of dual-balanced detector 64. In one embodiment, fiber laser transmitter 14 may be realized by the commercially available High Pulse-Energy Fiber Laser, Model Number AP-AMP-MOD, manufactured by AdValue Photonics, Inc. of Tucson, AZ.

Lidar system 10 further comprises output beam alignment assembly 26 that comprises dielectric laser mirrors 28 and 30, and half-wave plate 32. Mirror 28 directs output beam 22 to mirror 30 which then re-directs output beam 22 to half-wave plate 32. Mirrors 28 and 30 may finely align output beam 22 (to about 1.0 milliradian) in the direction of half-wave plate 32. Half-wave plate 32 is configured to rotate or adjust the input polarization of output beam 22 before passing through optical beam splitter 36, which is discussed in detail in the ensuing description. In an exemplary embodiment, each mirror 28 and 30 may be configured as a dielectric mirror. Unlike metallic mirrors (e.g., aluminum, gold, silver, etc.), a dielectric mirror resists the heat produced by the high pulse-energy of output beam 22 thereby avoiding optical damage. A dielectric mirror provides a degree of flatness less than λ/10 so as to maintain the phase front of output beam 22. In an exemplary embodiment, each mirror 28 and 30 is configured with a fused silica or UV grade fused silica substrate with a magnesium fluoride or titanium dioxide coating stack.

When lidar system 10 is used for meteorological purposes, target 35 is typically atmospheric aerosols, clouds, smoke or airborne foreign particles, precipitation, etc. Atmospheric backscatter 60 is the reflection of output beam 22 off of target 35. Backscatter routing assembly 13 routes atmospheric backscatter 60 to detector 64. Backscatter routing assembly 13 comprises thin-film optical beam splitter 36 which separates output beam 22 from atmospheric backscatter 60 based upon polarization. The first linear polarization of output beam 22 is optimized by half-wave plate 32. Beam splitter 36 is configured to allow output beam 22 to pass straight through to quarter-wave plate 42 while reflecting atmospheric backscatter 60 to mirror 38. Atmospheric backscatter 60 has a different polarization due to its reflection off of target 35 and resulting Doppler shift. This aspect is further discussed in detail in the ensuing description. Quarter-wave plate 42 provides several functions. One function is to convert the first linear polarization of output beam 22 to a first circular polarization. Circular polarization allows separation of output beam 22 and atmospheric backscatter 60 since atmospheric aerosols create a reflection having an opposite-sense circular polarization. Thus, atmospheric backscatter 60 has an opposite second circular polarization. Quarter-wave plate 42 converts the opposite second circular polarization of atmospheric backscatter 60 to a second linear polarization that is substantially orthogonal to the first linear polarization of output beam 22. Thin-film beam splitter 36 then reflects atmospheric backscatter 60 to mirror 38 which re-directs atmospheric backscatter 60 to mirror 40. Mirror 40 redirects atmospheric backscatter 60 to half-wave plate 44 which optimizes of the polarization of atmospheric backscatter 60. Beam splitter 36 may be configured with a rugged design in order to withstand the high energy of output beam 22 and minimize optical damage. Beam splitter 36 is configured with a dielectric coating in order to minimize absorption. Unlike circulators, which are typically used in prior art lidar receivers, beam splitter 36 is not vulnerable to optical damage when exposed to high pulse-energy laser beams. Mirrors 38 and 40 are configured as dielectric laser mirrors with a dielectric coating to prevent or minimize optical damage. Examples of suitable configurations for mirrors 38 and 40 include, but are not limited to, fused silica or UV grade fused silica substrate with a magnesium fluoride or titanium dioxide coating stack.

Backscatter routing assembly 13 further comprises mode-matching optical assembly 46 which receives atmospheric backscatter 60 from half-wave plate 44. Mode-matching optical assembly 46 matches the optical mode of output optical fiber 48 to the optical mode of atmospheric backscatter 60. Specifically, mode-matching optical assembly 46 matches the gaussian beam profile (also called a “mode”) of fiber laser transmitter 14 with the field of view of backscatter routing assembly 13. Mode-matching optical assembly 46 may comprise at least two lenses placed in front of optical fiber 48. In one embodiment, mode-matching optical assembly 46 may be realized by a collimator for transmitting laser light, wherein the collimator is arranged backwards so as to focus atmospheric backscatter 60 into optical fiber 48. A suitable commercially available collimator is the Fused Silica Fiber Collimator manufactured by Micro Laser Systems, Inc, of Garden Grove, California. Optical fiber 48 is configured to maintain the polarization of atmospheric backscatter 60.

Lidar system 10 further comprises beam expander 50. In an exemplary embodiment, beam expander 50 is a reflective beam expander. Beam expander 50 provides several functions. One function is to spatially expand output beam 22 so as to allow output beam 22 to remain small in size (less than about 20-cm in diameter) at distant ranges of many kilometers. Without this spatial expansion, diffraction would cause output beam 22 to be too large at distances of interest. Beam expander 50 may be adjusted to focus output beam 22 if a particular target distance is of interest. Another function of beam expander 50 is to collect atmospheric backscatter 60 from the atmosphere. In this regard, beam expander 50 functions as a telescope for the collection of the atmospheric backscatter 60. The collected atmospheric backscatter 60 is passed through quarter-wave plate 42. The degree of magnification of beam expander 50 depends upon the size of output beam 22. In one example, beam expander 50 provides a 10-20X magnification if output beam 22 has a beam size of 1-2 mm in diameter. Beam expander 50 is configured with primary mirror 52 and secondary mirror 54, each of which being configured with a dielectric coating to prevent or minimize absorption and optical damage.

As shown in FIG. 1, lidar system 10 further comprises detector 64. In an exemplary embodiment, detector 64 is configured as a dual-balanced detector. Detector 64 comprises fiber optic coupler 66. In this embodiment, fiber optic coupler 66 is configured as a 50/50 coupler. Fiber optic coupler 66 has a first input optically coupled to optical fiber 25 so as to receive pulsed local oscillator laser beam 24 provided by fiber laser oscillator 16. Fiber optic coupler 66 has a second input coupled to optical fiber 48 for receiving atmospheric backscatter 60. Fiber optic coupler 66 combines the electric fields of the light from pulsed local oscillator laser beam 24 and atmospheric backscatter 60. Fiber optic coupler 66 outputs light waves 68 and 70 over optical fibers 71 and 72, respectively. Each light wave 68 and 70 is formed by about 50% of the light from pulsed local oscillator laser beam 24 and about 50% of the light from atmospheric backscatter 60. Detector 64 further comprises a pair of photodiodes 74 and 76 connected in series so as to provide a dual-balanced configuration. Optical fiber 71 optically couples light wave 68 to photodiode 74 and optical fiber 72 optically couples light wave 70 to photodiode 76. As discussed in the foregoing description, the frequency difference between frequency F_{LO} of pulsed local oscillator laser beam 24 and frequency F_{OB} of output beam 22 is equal to the intermediate frequency F_{IF}. Since atmospheric backscatter 60 is the reflection of output beam 22 from target 35, the frequency of atmospheric backscatter 60 is substantially the same as the frequency F_{OB} of output beam 22. The dual-balanced configuration of photodiodes 74 and 76 results in heterodyne mixing of the combined light waves 68 and 70 to produce signal 84 which has a frequency that is equal to the intermediate frequency F_{IF}. Since the intermediate frequency F_{IF} is in the megahertz (MHz) range, signal 84 may be routed to digitizing and signal processing components (not shown) in order to extract wind measurement data as well as data representing the power level and wavelength of output beam 22.

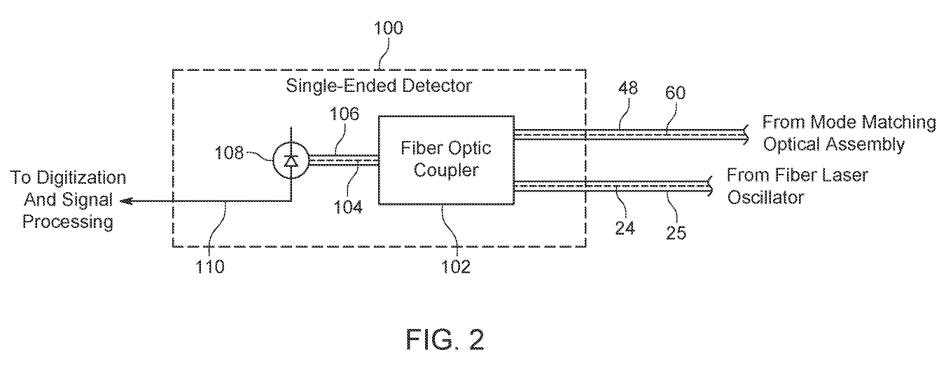

FIG. 2 shows an alternate detector 100 that may be used instead of detector 64. Detector 100 is configured as a single-ended detector. Detector 100 comprises fiber optic coupler 102. In this embodiment, fiber optic coupler 102 is configured as a 90/10 coupler. Fiber optic coupler 102 has a first input optically coupled to optical fiber 25 so as to receive pulsed local oscillator laser beam 24 from fiber laser oscillator 16. Fiber optic coupler 102 has a second input coupled to optical fiber 48 for receiving atmospheric backscatter 60. Fiber optic coupler 102 combines the electric fields of the light from pulsed local oscillator laser beam 24 and atmospheric backscatter 60. Fiber optic coupler 102 outputs light wave 104 over optical fiber 106. Light wave 104 is formed by about 90% of atmospheric backscatter 60 and about 10% of pulsed local oscillator laser beam 24. Detector 100 further comprises photodiode 108. Optical fiber 106 optically couples light wave 104 to photodiode 108 which produces signal 110. Signal 110 is then routed to digitizing and signal processing components (not shown) in order to extract wind measurement data as well as data representing the power level and wavelength of output beam 22. Benefits of detector 100 include reduced component count and associated costs.

Lidar receiver 12 may be safely used in coherent Doppler LiDAR systems that employ high-energy laser transmitters that generate laser pulse-energy exceeding 1 mJ. Lidar receiver 12 minimizes or eliminates the possibility of laser-induced damage to receiver components, unlike conventional lidar receivers which may suffer severe laser-induced damage to components when handling pulse energies greater than 100 microjoules. Lidar receiver 12 allows lidar system 10 to be used in many applications requiring high pulse-energy laser beam transmissions. Such applications include, but are not limited to, long distance wind monitoring for wind farms, aviation, aerospace travel and meteorology.

Aspects of the present invention have been described in detail with reference to the illustrated embodiments. Those skilled in the art will recognize, however, that many modifications may be made thereto without departing from the scope of the present invention. The present invention is not limited to the precise construction and compositions disclosed herein. Any and all modifications, changes and variations apparent from the foregoing descriptions are within the scope of the present disclosure as defined by the appended claims. Moreover, the present concepts expressly include any and all combinations and sub-combinations of the preceding elements and features.

What is claimed is:

1. A lidar receiver for use with a fiber laser transmitter that generates a high pulse-energy output beam having a first linear polarization and a first frequency and a pulsed local oscillator laser beam having a second frequency offset from the first frequency, the lidar receiver comprising:
an atmospheric backscatter routing assembly comprising:
a quarter-wave plate configured to receive atmospheric backscatter having a circular polarization and convert the circular polarization to a second linear polarization;
a beam splitter configured to reflect the atmospheric backscatter having the second linear polarization while allowing the high pulse-energy output beam having the first linear polarization to pass through the beam splitter;
a first optical assembly comprising a half-wave plate and a pair of dielectric laser mirrors that direct the atmospheric backscatter reflected by the beam splitter to the half-wave plate, the half-wave plate being configured to optimize the second linear polarization of the atmospheric backscatter; and
a second optical assembly comprising an output optical fiber and a mode-matching optical assembly for coupling the atmospheric backscatter emitted by the half-wave plate to the output optical fiber; and
a detector comprising:
a fiber optic coupler coupled to the output optical fiber and the pulsed local oscillator laser beam and configured to provide at least one output signal that comprises a portion of the atmospheric backscatter and a portion of the pulsed local oscillator laser beam; and
a photodetection circuit for converting the at least one output signal into an electrical signal usable for signal processing.

2. The lidar receiver according to claim 1 wherein the beam splitter is a thin-film beam splitter.

3. The lidar receiver according to claim 2 wherein the beam splitter is configured with a dielectric coating to minimize absorption.

4. The lidar receiver according to claim 1 wherein the fiber optic coupler is configured such that the at least one output signal comprises about 90% of the atmospheric backscatter and about 10% of the pulsed local oscillator laser beam.

5. The lidar receiver according to claim 4 wherein the photodetection circuit comprises a single photodiode for receiving light from the at least one output signal.

6. The lidar receiver according to claim 1 wherein the at least one output signal comprises two output signals and wherein the fiber optic coupler is configured such that each output signal comprises about 50% of the atmospheric backscatter and about 50% of the pulsed local oscillator laser beam.

7. The lidar receiver according to claim 6 wherein the photodetection circuit comprises a pair of photodiodes connected in series and wherein each photodiode receives light from a corresponding one of the output signals.

8. The lidar receiver according to claim 1 wherein the mode-matching optical assembly comprises a collimator arranged to focus the atmospheric backscatter into the output optical fiber.

9. A lidar receiver for use with a fiber laser transmitter that generates a high pulse-energy output beam having a first linear polarization and a first frequency and a pulsed local oscillator laser beam having a second frequency offset from the first frequency, the lidar receiver comprising:
an atmospheric backscatter routing assembly comprising:
a quarter-wave plate configured to receive atmospheric backscatter having a circular polarization and convert the circular polarization to a second linear polarization;
a thin-film beam splitter configured to reflect the atmospheric backscatter having the second linear polarization while allowing the high pulse-energy output beam having the first linear polarization to pass through the beam splitter, wherein the thin-film beam splitter is configured with a dielectric coating to minimize absorption;
a first optical assembly comprising a half-wave plate and a pair of dielectric laser mirrors to direct the atmospheric backscatter reflected by the thin-film beam splitter to the half-wave plate, the half-wave plate being configured to optimize the second linear polarization of the atmospheric backscatter; and
a second optical assembly comprising an output optical fiber and a mode-matching optical assembly for coupling the atmospheric backscatter emitted by the half-wave plate to the output optical fiber; and
a detector comprising:
a fiber optic coupler that is coupled to the output optical fiber and the pulsed local oscillator laser beam and configured to provide a pair of output signals, wherein each output signal comprises about 50% of the atmospheric backscatter and about 50% of the pulsed local oscillator laser beam; and
a dual-balanced photodetection circuit configured for receiving the light from the pair of output signals and in response, generating an electrical signal usable for signal processing.

10. A lidar system, comprising:
a fiber laser transmitter configured to generate a high pulse-energy output beam having a first linear polarization and a first frequency and a pulsed local oscillator laser beam having a second frequency offset from the first frequency;
a first optical assembly comprising a first half-wave plate and a first pair of dielectric laser mirrors to direct the high pulse-energy output beam to the first half-wave plate, the first half-wave plate being configured to rotate the polarization of the high pulse-energy output beam;
a beam splitter configured to allow the high pulse-energy output beam emitted by the first half-wave plate to pass through the beam splitter while simultaneously reflecting atmospheric backscatter having a second linear polarization;
a quarter-wave plate configured to convert the first linear polarization of the high pulse-energy output beam emitted by the beam splitter to a first circular polarization;
a beam expander configured to emit the high pulse-energy output beam having the first circular polarization into the atmosphere toward a target of interest and collect atmospheric backscatter having a second circular polarization that is opposite the first circular polarization;
wherein the quarter-wave plate is further configured to convert the second circular polarization of the atmospheric backscatter to the second linear polarization;
wherein the beam splitter reflects the atmospheric backscatter having the second linear polarization;
a second optical assembly comprising a second half-wave plate and a second pair of dielectric laser mirrors to direct the atmospheric backscatter reflected by the beam splitter to the second half-wave plate, the second half-wave plate being configured to optimize the second linear polarization of the atmospheric backscatter;
a third optical assembly comprising an output optical fiber and a mode-matching optical assembly configured to couple the atmospheric backscatter emitted by the second half-wave plate to the output optical fiber; and
a detector comprising:
a fiber optic coupler that is coupled to the output optical fiber and the pulsed local oscillator laser beam and configured to provide at least one output signal that comprises a portion of the atmospheric backscatter and a portion of the pulsed local oscillator laser beam; and
a photodetection circuit for converting the at least one output signal into an electrical signal usable for signal processing.

11. The lidar system according to claim 10 wherein the beam splitter is a thin-film beam splitter.

12. The lidar system according to claim 11 wherein the beam splitter is configured with a dielectric coating to minimize absorption.

13. The lidar system according to claim 10wherein the fiber optic coupler is configured such that the at least one output signal comprises about 90% of the atmospheric backscatter and about 10% of the pulsed local oscillator laser beam.

14. The lidar system according to claim 13 wherein the photodetection circuit comprises a single photodiode for receiving light from the at least one output signal.

15. The lidar system according to claim 10 wherein the at least one output signal comprises two output signals and wherein the fiber optic coupler is configured such that each output signal comprises about 50% of the atmospheric backscatter and about 50% of the pulsed local oscillator laser beam.

16. The lidar system according to claim 15 wherein the photodetection circuit comprises a pair of photodiodes connected in series, wherein each photodiode receives light from a corresponding one of the output signals.

17. The lidar system according to claim 10 wherein the mode-matching optical assembly comprises a collimator arranged to focus the atmospheric backscatter into the output optical fiber.

18. The lidar system according to claim 10 wherein the beam expander comprises a primary dielectric laser mirror and a secondary dielectric laser mirror.

19. The lidar system according to claim 10 wherein the fiber laser transmitter comprises a fiber laser oscillator configured to generate a pulsed laser beam and the pulsed local oscillator laser beam.

20. The lidar system according to claim 19 wherein the fiber laser transmitter further comprises a fiber laser amplifier configured to amplify the pulsed laser beam so as to generate the high pulse-energy output beam.
